(19) United States
(12) Patent Application Publication
(10) Pub. No.: US 2012/0105456 A1
(43) Pub. Date: May 3, 2012

(54) Interactive, multi-environment application for rich social profiles and generalized personal expression

(76) Inventors: Scott Ernst, Eugene, OR (US); Eric D. Wills, Eugene, OR (US); Daniel D. Mayhew, Eugene, OR (US)

(21) Appl. No.: 13/152,058

(22) Filed: Jun. 2, 2011

Related U.S. Application Data
(60) Provisional application No. 61/396,801, filed on Jun. 2, 2010.

(51) Int. Cl. G06T 13/00

(52) U.S. Cl. 345/473

(57) ABSTRACT

A system and method provides to users the ability to create fully extensible, visually-dominated tokens and associated tackboards, the ability to create fully extensible, visually-dominated collections of tokens, the ability to create an adaptable, interactive, animated, visual collage that supports visualization of the collection, and the ability to create social capabilities to communicate, share, explore, and interact with other users.

### CROSS-REFERENCE TO RELATED APPLICATIONS

This application claims priority from U.S. Provisional Patent Application 61/396,801 filed Jun. 2, 2010, which is incorporated herein by reference.

### FIELD OF THE INVENTION

The present invention relates generally to methods for sharing multiple pieces of content on digital networks. More specifically, it relates to methods for providing extensible visual expression for content sharing applications.

### SUMMARY

In one aspect, the invention provides a method implemented by a user computer and/or server, as appropriate, comprising providing to users the ability to create fully extensible, visually-dominated tokens and associated tackboards; providing to users the ability to create fully extensible, visually-dominated collections of tokens; providing to users the ability to create an adaptable, interactive, animated, visual collage that supports visualization of the collection; and providing to users the ability to create social capabilities to communicate, share, explore, and interact with other users.

### DESCRIPTION OF THE DRAWINGS

FIG. 1: Example of tokens arrayed inside a synth. In the application, these tokens are animated within the synth for interactive display. Each token represents anything of interest or value to the creator/adopter, who is represented by the image in the lower right.

FIG. 2: Another example of tokens displayed inside the synth. Once again the tokens are animated interactively, with user control driving the animation. The arrows on the sides represent paging of the token display for large token collections. The number of tokens that can be displayed within a synth is determined procedurally at runtime based on the client device's rendering capabilities. The number of tokens displayed, consequently, increases over time as devices (both hardware and software) become capable of higher-performance rendering, mostly by taking advantage of improvements in graphics cards.

FIG. 3: Example of a token-tackboard pair for a trip to China. The token is located in upper left corner in this example. Each of the frames/billboards/boxes displayed on the screen represents a piece of content. Clicking on any of the boxes will open the content up for consumption the same way clicking on a video will start a video playing. The content type is shown in the upper right corners of each frame, in this case there are content types for text, audio, web links, and YouTube videos. This represents only a small fraction of the possible content types that can be included, a number which grows over time.

FIG. 4: Every piece of content included in a tackboard can be customized/personalized for that particular user. Hence, every content renderer has an associated editor as well, an example of which is shown here for an image slideshow. The window shows thumbnails of the current array of slides, which can be dragged and dropped to reorder, or clicked to be edited and personalized with labels, captions, tags, and more.

FIG. 5: Token style customization selection. Example of a menu built using an external constructor. The actual menu class resides in the GUI application piece, while buttons, content, and layout information is stored in the token editor application piece.

FIG. 6: A second example of the external constructor. This menu uses the same host class as the one in FIG. 11, but this constructor is stored in the program settings application piece and gives a completely different look to the menu.

FIG. 7: Another type of external constructor object. Once again the host information is stored within the GUI application piece, but the constructor class that actually builds the menu resides within the tackboard application piece.

FIG. 8: Diagram showing the full-stream functionality. The application core holds the registration manager, which handles dynamically added application elements through the discussed communication methods. The pathways between the registration manager and the application elements are bi-directional, operational aspects work both ways, and compound, application elements can communicate and interact with each other through the registration pathways. Example shows the external constructor pattern where the constructor class resides in one element, the host class in another application element, and the instance of the class pairing instantiated in a third, different application element.

FIG. 9: Example of tokens displayed as a search result with associated metadata accompanying the visual representation. This example also hints at the wide variety of possible subjects for a token including products, personalities, media, organizations, activities, events, and more.

FIG. 10: Example of application displaying a token inside its integrated-site web-deployment configuration container. This specific deployment container allows a level of communication between the application, both client and server, and the host web site, resulting in an expanded application interface for greater interaction in that kind of web context. The interface expansion is demonstrated by the elements shown at the top, which represent application client functionality that has been produced externally to the application in order to provide an interface common to web site environments. The integrated-site web-deployment configuration container handles the communication between the application and its environment to allow the web site to drive the client when necessary.

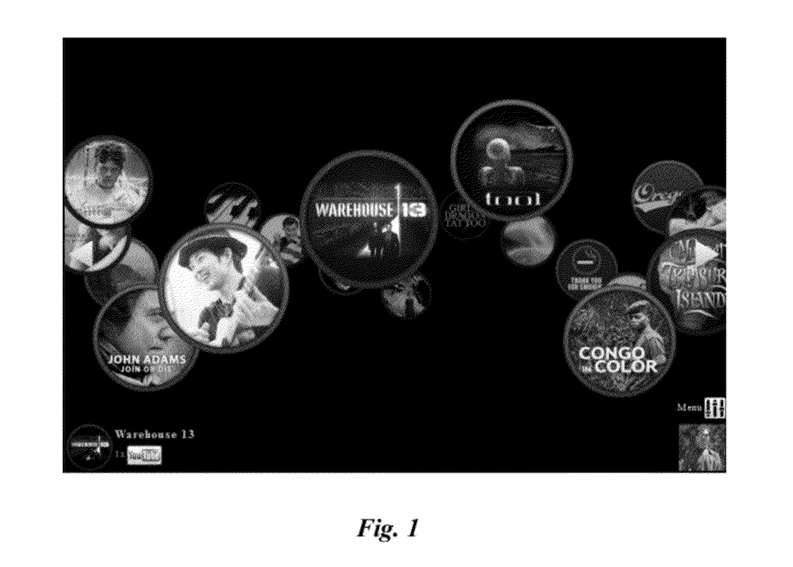

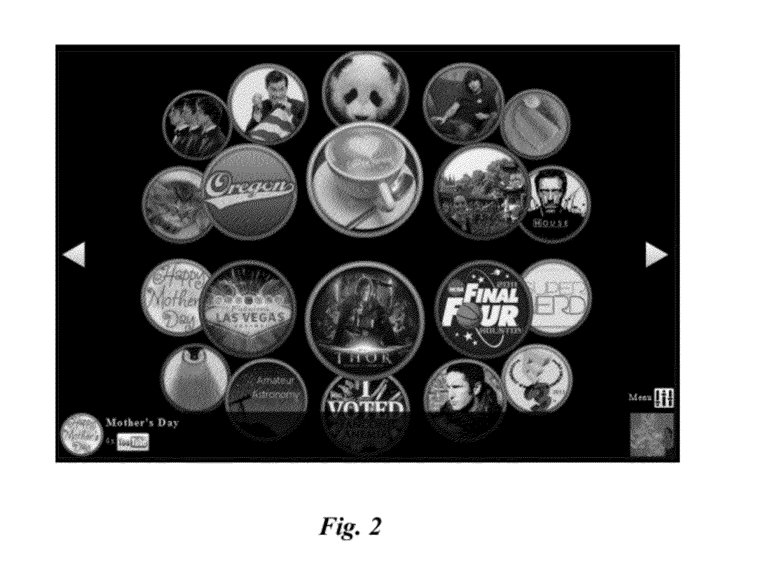

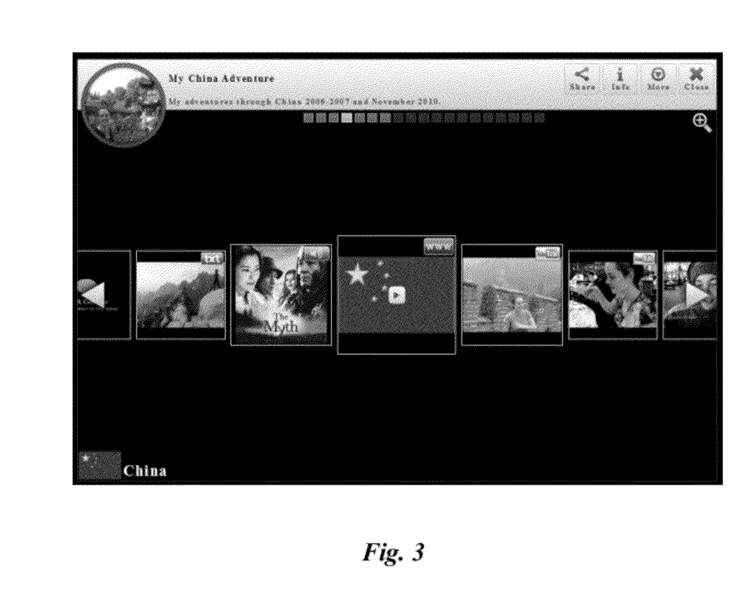

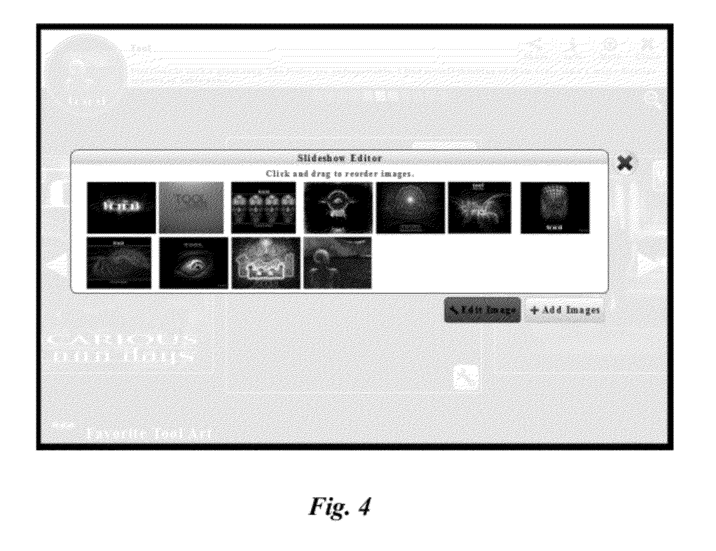

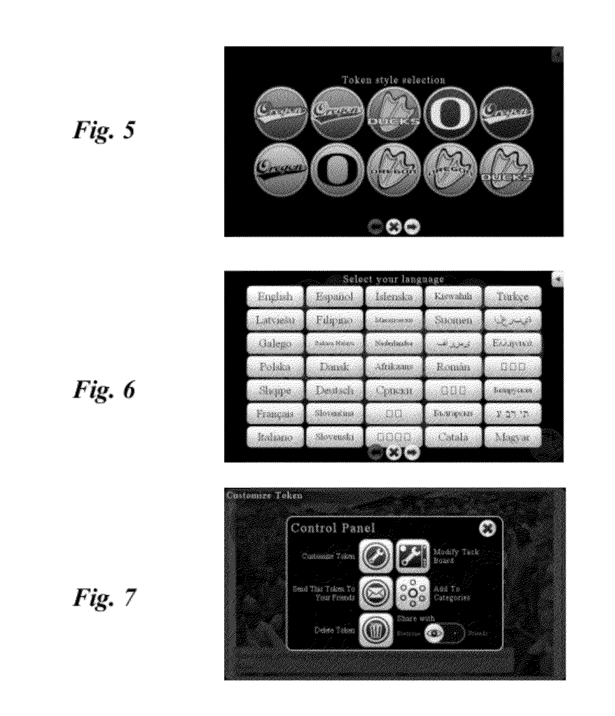

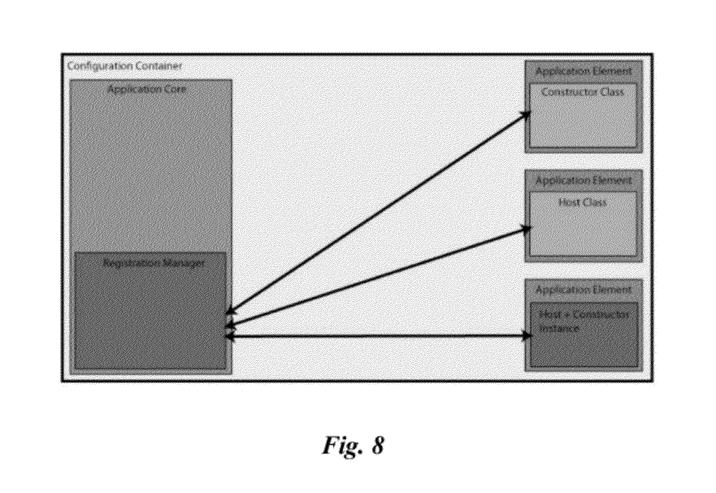

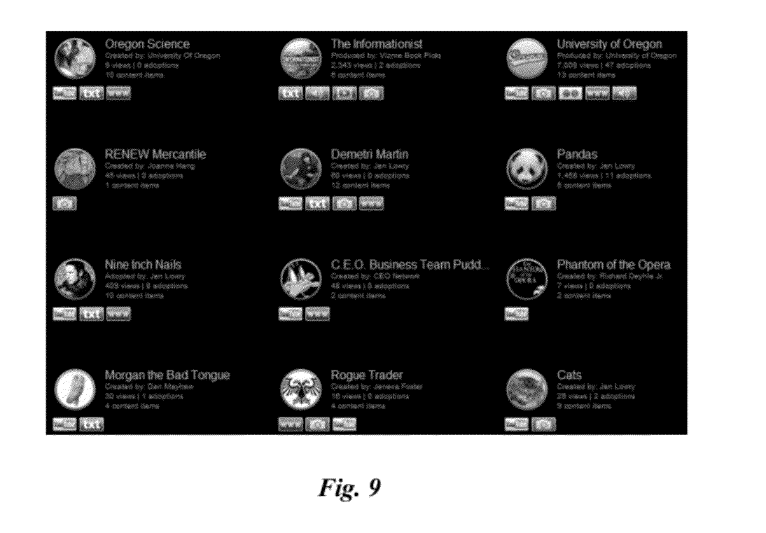

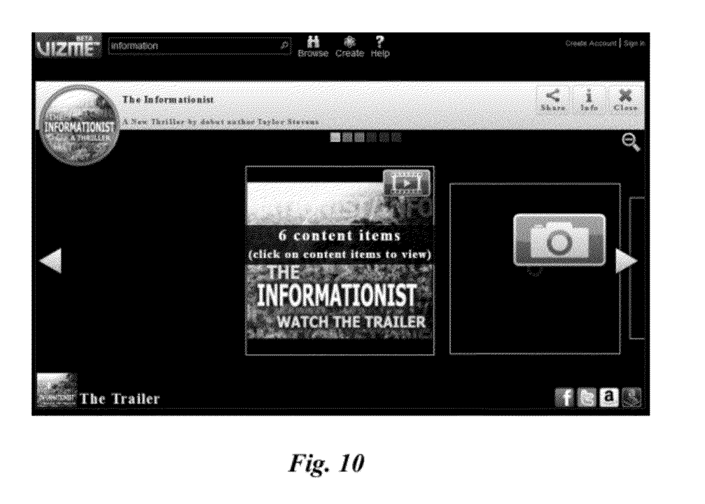

### DETAILED DESCRIPTION

In a preferred embodiment of the invention, a computer-implemented method is provided which may be realized as a computer-implemented system for visual expression and promotion. Its purpose is to allow a person, persons, or organization, herein termed the creator, to express and share over a digital communication network their interests to others, herein termed users, through an interactive, multi-media digital experience. It is unique and novel in providing for visibility across a broad range of digital computer networking contexts by employing a fully customizable visual content delivery system built around visual hyperlinks, herein termed tokens, that are each uniquely connected to a digital content mash-up or mix, herein termed tackboard. The system may be deployed in a client-server model, where the server manages back-end functionality and client accounts. Tokens can be created by any account holder, either personal or as an organization, and multiple tokens created by a single account holder are grouped into a general or directed category, herein termed a collection (formerly referred to as a profile). The application facilitates:
1. the creation of fully extensible, visually-dominated tokens and in so doing the same applies to the associated tackboards.
2. the creation of a fully extensible, visually-dominated collection,
3. an adaptable, interactive, animated, visual collage, herein termed a synth, that supports visualization of the collection, and
4. the social capabilities to communicate, share, explore, and interact with other users.

By design, the collections and synth co-evolve as creators develop, experience, share, and interact with others. Once an individual's account is activated, creators can customize the synth (e.g., modifying the interface, content items, spatial views, and dynamics), allowing for nearly endless personalization. Just as a collection grows and changes, so can its synth for different social contexts and applications. That is, rather than being tied to any one web portal and platform, embodiments of the invention are built on web technology that can be applied across a large and increasing range of digital environments, from simple embedding on web pages, to integration into social networking sites, to personalized mobile device applications. This broad applicability allows a creator to develop and manage their dynamic and evolving collection and to expose it as they desire in different ways across a different application domains.

The invention may be realized as a computer-implemented method comprising various steps to perform and/or implement the various features and functions described herein, where the steps are performed by a user computer and/or server, as appropriate. The invention may also be realized as a digital storage medium tangibly embodying machine-readable instructions executable by a computer, where the instructions similarly comprise various steps to perform and/or implement the various features and functions described herein.

### INVENTION MOTIVATION

At present content is spread out all over the web in a largely segregated fashion, with video sharing sites, image sharing sites, audio sharing sites, app sharing sites, etc. Three methods currently exist to share such content:
1. Share each piece separately. For example, in social network wall posts or microblog posts, a piece of content can be sent to friends/followers.
2. Bundle the content together as a group of links, e.g. as recently done by bit.ly. Multiple pieces of content can then be shared by navigating to each link. However, this keeps the content segregated to the source hosts.
3. Embed content in a blog or website. This approach is the only existing one that allows multiple pieces of content to exist in the same place.

Preferred embodiments of the invention may create a fourth alternative that gives anyone the freedom of the embedding (method 3) while removing the need to create a blog or website in which to house the content. This allows such individuals and/or organizations to personalize and customize their content along with content found all over the web in ways not possible by direct sharing (methods 1 & 2), which just link to the host site and offer no intermediate point of customization. With the growth of rich, visual content on the web, preferred embodiments can move the expression of personality and individuality from text to graphics and makes it an interactive, social experience providing much greater value to the users than any of its antecedents.

### Elements of the Invention

Note: See Details of the Invention section for explanation of terms and functionality mentioned as elements of the invention. A preferred embodiment of the invention provides a client application that, through an ever-increasing number of deployment configurations, supports the management of creation and viewing tokens. In the client application users develop a collection through the referential linking, cloning, adoption, creation, and customization of tokens, which are displayed by the client as a synth (or in web page formats as visual lists). Tokens may be linked, cloned, or adopted from other collections or through direct search results of a token database. Each token is paired to a tackboard, which opens when a user requests access to it through the token. The tackboard is fully customizable in terms of personalization, content, and design by users, but it is supported by a layout management system that simplifies the display of tackboard items for users by procedurally generating the template layouts for users to begin with.

A preferred embodiment of the invention includes communication mechanisms for both external sharing in other sites and networks as well as an mail component, which allows for the efficient sharing of tokens between users. The mail component works through an inbox, similar in concept to conventional email, where tokens sent by users are displayed with optional messages sent with them as part of the communication process. Unlike traditional email, the tokens within an inbox are active references to the original token, not a copy sent to the user. As such, updates to the original token effect the display of the mailed token references at any time, which facilitates a much more dynamic relationship between sender and receiver than other digital mail technologies.

The client application represents only part of the actual application, the rest of which is handled, transparently to the user, as back-end, cloud computing operations for the manipulation of the underlying data, for the purpose of providing a high-end user experience that goes beyond the capabilities of typical consumer electronics. Many of the cloud operations provide common application features, e.g. mail and search, but they have been redesigned and/or augmented to front end a visual interface as opposed to a textual one, or a static visual reference one such as an image search engine.

Embodiments of the invention are thus comprised, in part, of a novel graphical and web technology but, in equal measure, to the open-ended extensibility the architecture provides by leveraging cloud operations to create a cross-platform, cross-location, cross-device, modular application that builds itself in a unique, full-stream approach where the application builds itself by streaming in pieces of the complete application dynamically in response to user actions.

### Benefits of the Invention

The Users Experience: Embodiments of the invention may be realized as an application that enhances the digital lifestyle with its unique design and deployment capabilities.

From the client, which provides a cross-device, cross-platform, cross-technology, dynamic environment for the display of user data, to the tokens that provide visually contextual connections to an endless number of user ideas, interests, and conceptions and the tackboard as a substantive location for users to customize, annotate and express themselves, Embodiments of the invention provide an unprecedented digital experience for its users.

Mobility: Preferred embodiments of the invention may be built on interoperable web technologies (e.g. PHP, Python, Java, Flash, Javascript, HTML5) that integrate into all internet-enabled environments easily using lightweight deployment-configuration containers that reduce the complexity of multiple locales by handling the localization of the environment instead of the application itself. Preferred embodiment of the invention also utilizes a new full-stream technology that allows for advanced application streaming in addition to streaming the content and data within the application. Using the full-stream technology in combination with the lightweight deployment-configuration containers, embodiments of the invention can be included as part of any internet-enabled environment.

### DETAILS OF THE INVENTION

Client application: The graphically-based application can be embedded in any of a number of digital contexts from the application's home page, web pages, blogs, social networks, and other browser based locales to desktop, entertainment technology, and mobile device and computing standalone applications. The only locale requirement is that the application has access to the internet.

Deployment-configuration containers: Configurations vary depending on the client application's locale and each unique configuration is handled by a container object that wraps the client application and modifies its functionality to fit that specific configuration. Each of these containers loads, initializes, and interacts with the actual client application to modify it for use in that specific locale. These containers represent the deployment apparatus around which the application is deployed and are what is installed, linked, or embedded by users instead of the client application itself. The choice of the container is handled transparently to the user as they select a locale for the installation/embed process and the correct container is selected for that location as part of that process.

Synth: The extensible, interactive, visual environment in which the core visual aspects of the application reside. The synth is a dynamic, screen-scalable display environment, with adaptable display representations that work on screen resolutions from below half of the quarter video graphics array (QVGA) standard up beyond the wide super extended graphics array (WSXGA) standard for any possible display aspect ratio, allowing for deployment to an endless number of configurations and locales. The Synth is aware of the available size and aspect ratio of the user's display and adjusts its display environment accordingly to achieve efficient display over such a wide range of resolutions and aspect ratios. The Synth is also capable of responding to in situ changes in resolution or aspect ratio, allowing for resizing behavior by the user in cases where the application graphical user interface (GUI) is embedded within a dynamically sized host environment. The synth is interactive, with physically-based responses to user interaction, which allows for a natural display of a large number of tokens within the confines of the application window. As such, the synth is a responsive interface in addition to the traditional user-interface elements that overlay and interact with it.

Views: Part of the synth operation is the efficient and interactive display of the tokens, which is handled by an extensible view system, which like the rest of the application, is completely modular and allows for extension of views as well as custom defined views by 3^{rd} parties. The views implement faux-physical properties as part of their design to provide as natural as possible interface for the rendering of the application GUI and the synth.

Tokens: are visual tags used to represent any conception, including persons, places, things, ideas, emotions, etc., and are represented as a visual formulation of that conception. They can be created by commercial developers, or users themselves to represent a context. Tokens generally reside within the Synth but are distinct objects that also reside in other locations where appropriate, e.g., embedding directly into a social network page as a display or link to the token within the application.

Tackboards: are digital mash-ups of content, e.g. text, audio, video, images, and interactive applications, from all kinds of sources. The content within a tackboard is selected by users, with optional templates provided by sponsors, and can be modified at any point by that user as an ongoing connection to the concept represented by the tackboard's token. Tackboards are self-contained objects with functionality shared between them, but unique to each tackboard. This allows multiple tackboards to live seamlessly within a user's instance of the client application, each one a unique customization by its owner. The key to tackboards is the ability for users to customize them with the content of their choice, no matter what the source of that content is or how it was made available to the users, e.g., from a sponsor to something they upload themselves. In antecedent applications that employ a similar concept these technologies can more appropriately be described as containers of stuff. What the present application does differently is provide a very concise interface for editing and managing the tackboard by providing an interaction framework of editing and management tools around the tackboard to enhance its efficacy as a display for users. The clear difference in a tackboard is how easy it is to create, manage, and maintain. In addition, the tackboard model allows for much higher content quantization scalability than any other existing content concatenation method.

Dynamic Content Quantization Scalability: A feature of the token-tackboard design, this essentially results in faster load times and more dynamic browsing when many pieces of content are combined. It's best to understand the concept from the reverse and recollect loading a blog or web page with many pieces of content embedded on them and remembering how long it took for that web page to load and display. The tackboard model breaks free of this loading paradigm and loads multiple pieces of content on demand instead of a single bulk request and uses the tackboard format to anticipate load behaviors. This provides a much faster browsing experience, critically important to low bandwidth mobile connections.

Collections: Tokens are grouped into collections by ownership, categorically, or by any other relationship of value for display, e.g. by popularity, geo-location, or rating. The client is capable of displaying collections for any relationship in which the back-end data can be categorized or sorted. Collections can be displayed either as by a synth or by any number of more traditional displays, e.g. lists.

“Token” i.e. Token-Tackboard Pair: The term token is also used to describe the super-concept of the combination of a token and its corresponding tackboard. This pairing between the token, a visual and accessible link, and its tackboard, a content interactive, user-customizable digital mash-up, is the primary source of the benefit in the user-experience of the application. Antecedent applications in this space lack such a pairing in any novel fashion, usually relying on text or static images as the link and not providing a substantive place for content customization. So while the idea of a link to content exists all over the internet, from text links to web pages or image links to embedded content, in no case is there a well-defined entity that is the link and content pair. By encapsulating the link-content display in this way the user is provided with a much more powerful interaction mechanism for creating, organizing, sharing, and exploring ideas. This self-contained pairing also provides a greater mobility as a communication mechanism because the tackboard content is self-contained and paired to a token, so the sending and receiving of tokens through any digital communication means will carry the information in the tackboard along with it.

Mail: In addition to being a novel link, the token-tackboard pairing is also transmittable between users through Mail component, which is a visual, digital mail system designed around the token-tackboard pair. As part of this communication process users can add messages to accompany the mail, and have access to traditional email actions like reply and forward, all implemented for this visual mail system. A key difference between traditional email and Mail component is that mail is referential instead of copied, so the token-tackboard pair received by a user in Mail component remains actively linked to the original source token and changes to the source token are reflected in the mail. Such a relationship provides a dynamic link as part of the communication process, instead of a single static transmission.

Full-Stream Modularity: An important part of the user-experience and mobility of the application is its ability to load quickly on internet-enabled devices of all types while being fully-extensible with a wide array of features, customizations, and application states. This is achieved through the implementation of a novel streaming approach, termed full-stream, where the application is itself streamed on demand in addition to the assets, content, and data. What makes full-stream different from traditional modular streaming applications is the creation of a cascading central class registration object that behaves in a fashion similar to the central nervous system in an anatomical system.

When the application is invoked, the configuration container, acting as the exoskeleton, downloads the vital organs and brain of the application, called the core. The user interface and all of the additional functionality is then downloaded as needed in response to actions and requests of the user. When a new piece of the application is streamed it attaches itself to the registry and the classes, which is possible using dynamic class relationships between the non-core elements of the application and core registration object. During the attach process direct functional and indirect event pathways are created between the new application element and the existing structure, which integrate the element into the application at runtime and allow for nonlinear growth of the application over the course of user activity.

A related limitation of prior modular streaming paradigms is the inability to extend classes. Instead the classes are extended within their host application element for use and then interfaced into the new elements. However, this leads to asymmetric modularity as class relationships become more complex. To circumvent this problem the application implements what we call an external constructor pattern. The elements of the external constructor pattern are a paired host class and constructor class. The host class is the object that will be ultimately utilized by the application and resides within the original host application element. A host class is an empty shell with general functionality that can be repurposed for a very wide range of uses but cannot be directly instantiated without providing a valid constructor class. The constructor class, which is independent of the host application and host class hierarchies, resides in the application element for which it is needed. The constructor class then acts as the constructor for the host class, instantiated and passed in as part of the construction of the host class, and is responsible for all of the custom behaviors for the constructed host class. Such an approach allows for a very wide range of class behaviors from the host class in a fully modular and distributed application without the overhead or deficiencies of a traditional class hierarchy.

1. A system for visual expression in a computer networking environment, the system comprising:
a token component providing to users the ability to create fully extensible, visually-dominated tokens and associated tackboards;
a collection component providing to users the ability to create fully extensible, visually-dominated collections of tokens;
a synth component providing to users the ability to create an adaptable, interactive, animated, visual collage that supports visualization of the collection; and
a social networking component providing to users the ability to create social capabilities to communicate, share, explore, and interact with other users.
